(19) United States
(12) Patent Application Publication
(10) Pub. No.: US 2010/0227129 A1
(43) Pub. Date: Sep. 9, 2010

(54) IMAGE-FORMING METHOD AND RECORD

(75) Inventors: Tsuyoshi Sano, Shiojiri-shi (JP); Takayoshi Kagata, Shiojiri-shi (JP); Akio Ito, Chino-shi (JP)

Correspondence Address: LADAS & PARRY, 26 West 61st Street, New York, NY, 10023, US

(73) Assignee: SEIKO EPSON CORPORATION

(21) Appl. No.: 12/714,573

(22) Filed: Mar. 1, 2010

(30) Foreign Application Priority Data
Mar. 3, 2009 (JP) 2009-048918

(51) Int. Cl. B32B 3/00; B05D 5/04

(52) U.S. Cl. 428/195.1; 427/288

(57) ABSTRACT

An image-forming method for forming an image on a sheet of fabric with an ink composition includes forming the image on the fabric sheet with the ink composition and pressing the fabric sheet subsequently to the formation of the image. The ink composition contains a colorant containing hollow resin particles or metal compound particles and also contains a resin dispersion containing resin particles having an average size greater than the average particle size of the colorant.

### BACKGROUND

1. Technical Field

The present invention relates to image-forming methods capable of forming images having good fixability and fastness on sheets of fabric. In particular, the present invention relates to an image-forming method which is capable of forming an image having good fixability and fastness on a sheet of fabric and which is applicable to ink jet recording methods and also relates to a record obtained by the image-forming method.

2. Related Art

JP-A-2005-161583 discloses a method for forming a white ink jet image on a sheet of fabric by an ink jet recording process using a white ink jet ink containing fine hollow polymer particles serving as a white pigment. In the image-forming method, the fabric sheet is subjected to printing several times by the ink jet recording process, is subjected to preliminary heat fixing at least once while being subjected to printing several times, and is subjected to final heat fixing subsequently to final printing. The image-forming method is capable of providing a print having sufficient visibility and high washing fastness.

However, the image-forming method has problems in that printing needs to be performed several times, the amount of ink used is large, and the time taken to form an image is long.

### SUMMARY

An advantage of some aspects of the invention is to provide a novel image-forming method which is capable of forming an image having good fastness on a sheet of fabric in a short time with a small amount of ink and which is capable of fixing a colorant to the fabric sheet. An advantage of some aspects of the invention is to provide a record obtained by the image-forming method.

The present invention provides an image-forming method for forming an image on a sheet of fabric with an ink composition. The image-forming method includes forming the image on the fabric sheet with the ink composition and pressing the fabric sheet subsequently to the formation of the image. The ink composition contains a colorant containing hollow resin particles or metal compound particles and also contains a resin dispersion containing resin particles having an average size greater than the average particle size of the colorant.

In the image-forming method, the average size of the resin particles is 2.5 times greater than the average particle size of the colorant.

In the image-forming method, the colorant has an average particle size of 0.01 to 1 μm.

In the image-forming method, the difference between the average particle size of the colorant and the average size of the resin particles is 1 μm or more.

In the image-forming method, the content of the colorant in the ink composition is 5% to 20% by mass.

In the image-forming method, the resin particles are made of a polyurethane resin.

In the image-forming method, the image is formed under heating conditions.

In the image-forming method, the heating temperature is higher than or equal to the glass transition temperature or softening point of the resin particles.

The image-forming method is applicable to ink jet recording methods.

The present invention provides a record obtained by the image-forming method.

The present invention provides a novel image-forming method which is capable of forming an image having good fastness on a sheet of fabric in a short time with a small amount of ink and which is capable of fixing a colorant to the fabric sheet. The image-forming method uses an ink composition containing hollow resin particles or metal compound particles used as a white colorant and therefore is suitable for forming a white image on a sheet of fabric.

### BRIEF DESCRIPTION OF THE DRAWINGS

The invention will be described with reference to the accompanying drawings, wherein like numbers reference like elements.

FIG. 1 is a schematic sectional view of a coating formed on a recording medium, or a sheet of fabric, by an image-forming method according to an embodiment of the present invention.

FIG. 2 is a schematic sectional view of the coating subjected to external load.

### DESCRIPTION OF EXEMPLARY EMBODIMENTS

Preferred embodiments of the present invention will now be described in detail.

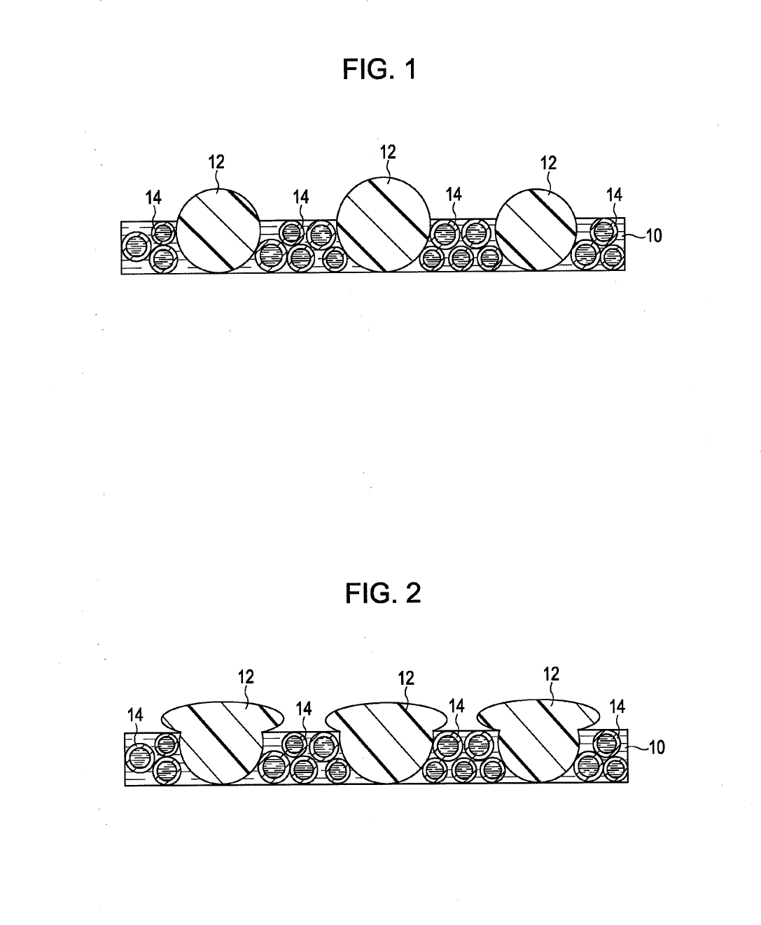

FIG. 1 is a schematic sectional view of a coating 10 formed on a sheet of fabric by an image-forming method according to an embodiment of the present invention, the fabric sheet being a recording medium. FIG. 2 is a schematic sectional view of the coating 10 subjected to external load.

The coating 10 is formed by applying an ink composition used in the image-forming method to the fabric sheet. Resin particles 12 have an average size greater than the average particle size of a colorant 14 containing hollow resin particles or metal compound particles. Therefore, portions of the resin particles 12 protrude from the coating 10 as shown in FIG. 1. There is a problem in that the hollow resin particles, which are contained in the colorant 14, are unlikely to be fixed to recording media because the hollow resin particles have an average size greater than that of particles of common pigments. However, the use of the resin particles 12, which have an average size greater than the average particle size of the colorant 14, allows the colorant 14 to be sufficiently fixed to the fabric sheet even if the ink composition is applied to the fabric sheet only once and also allows the coating 10 to be protected. This is because the application of pressure or external load such as friction to the upper surface of the coating 10 causes the protruding portions of the resin particles 12 to be distorted such that the protruding portions thereof spread on the upper surface of the coating 10. Therefore, the upper surface of the coating 10 is protected by the distorted protruding portions of the resin particles 12; hence, the coating 10 exhibits good fastness (rubfastness).

The ink composition contains the colorant 14, which contains the hollow resin particles or the metal compound particles, and a resin dispersion containing the resin particles 12. The resin particles 12 have an average size greater than the average particle size of the colorant 14.

The hollow resin particles have internal pores and shells made of a resin having liquid permeability. When the hollow resin particles are present in an aqueous ink composition, the internal pores are filled with an aqueous medium. The hollow resin particles filled with the aqueous medium have a density substantially equal to that of the aqueous medium and therefore can be stably dispersed in the aqueous ink composition without settling. This allows the aqueous ink composition to have high storage stability and ejection stability.

After the aqueous ink composition is applied to a recording medium, the aqueous medium escapes from the hollow resin particles during drying and therefore the internal pores become empty. When the hollow resin particles contain air, the hollow resin particles exhibit a white color because the hollow resin particles have resin and air portions having different refractive indices and therefore effectively scatter incident light. The resin contained in the hollow resin particles may be colored. In this case, the resin in the hollow resin particles needs to be colored so as to be light-transmissive.

The hollow resin particles are not particularly limited and may be known ones. The hollow resin particles may be those disclosed in, for example, U.S. Pat. Nos. 4,880,465 or 3,562,754.

The hollow resin particles preferably have an average size (outer diameter) of 0.01 to 1 μm, more preferably 0.2 to 1 μm, and further more preferably 0.4 to 0.8 μm. When the outer diameter of the hollow resin particles is greater than 1 μm, the hollow resin particles have low dispersion stability and therefore are likely to settle down. Furthermore, the hollow resin particles are likely to clog ink jet recording heads, thereby causing a reduction in reliability. When the outer diameter thereof is less than 0.01 μm, the hollow resin particles are likely to have insufficient color density and whiteness. In order to secure the color density and whiteness of the hollow resin particles, the average size of the hollow resin particles is preferably 0.2 μm or more. The hollow resin particles preferably have an inner diameter of 0.1 to 0.8 μm.

The average size of the hollow resin particles can be measured with a laser diffraction-scattering particle size distribution analyzer. A useful example of the laser diffraction-scattering particle size distribution analyzer is a dynamic light scattering particle size distribution analyzer, Microtrack UPA, available from Nikkiso Co., Ltd.

The content (solid content) of the hollow resin particles in the ink composition is preferably 5% to 20% and more preferably 8% to 15% on a mass basis. When the content (solid content) of the hollow resin particles therein is greater than 20% by mass, ink jet recording heads are possibly clogged, thereby causing a reduction in reliability. When the content thereof is less than 5% by mass, the color density and whiteness of the hollow resin particles are likely to be insufficient.

A process for preparing the hollow resin particles is not particularly limited. The hollow resin particles can be prepared by a known process. The hollow resin particles may be prepared by, for example, an emulsion polymerization process in which a vinyl monomer, a surfactant, a polymerization initiator, and an aqueous dispersion medium are mixed together in a nitrogen atmosphere while being heated and thereby a hollow resin particle emulsion is prepared.

Examples of the vinyl monomer include monofunctional vinyl monomers such as styrene, vinyl toluene, ethylene, vinyl acetate, vinyl chloride, vinylidene chloride, acrylonitrile, (meth)acrylamide, and (meth)acrylic esters. Examples of the (meth)acrylic esters include methyl acrylate, methyl methacrylate, ethyl(meth)acrylate, butyl (meth)acrylate, 2-hydroxyethyl methacrylate, 2-ethylhexyl (meth)acrylate, benzyl(meth)acrylate, lauryl(meth)acrylate, oleyl(meth)acrylate, palmityl(meth)acrylate, and stearyl (meth)acrylate.

Other examples of the vinyl monomer include bifunctional vinyl monomers such as divinyl benzene, allyl methacrylate, ethylene glycol dimethacrylate, 1,3-butanediol dimethacrylate, diethylene glycol dimethacrylate, and trimethylolpropane trimethacrylate. The hollow resin particles can be prepared in such a manner that one or more of the monofunctional vinyl monomers and one or more of the bifunctional vinyl monomers are copolymerized and the obtained copolymer is highly cross-linked. This allows the hollow resin particles to have light-scattering ability, heat resistance, solvent resistance, solvent dispersibility, and other properties.

The surfactant may be one capable of forming molecular aggregates such as micelles in water. Examples of the surfactant include anionic surfactants, nonionic surfactants, cationic surfactants, and amphoteric surfactants.

Examples of the polymerization initiator include known water-soluble compounds such as hydrogen peroxide and potassium persulfate.

Examples of the aqueous dispersion medium include water and hydrophilic organic solvent-water mixtures.

The metal compound particles are preferably made of a compound, such as a metal oxide, barium sulfate, or calcium carbonate, conventionally used as a pigment. The metal oxide is not particularly limited and is preferably titanium dioxide, zinc oxide, silica, alumina, magnesium oxide, or the like. In particular, the metal compound particles are preferably made of titanium dioxide or alumina. Other metal compound particles with a color other than white can be used herein.

The content of the metal compound particles in the ink composition is preferably 1% to 20%, more preferably 5% to 20%, and further more preferably 5% to 10% on a mass basis. When the content of the metal compound particles therein is greater than 20% by mass, ink jet recording heads are possibly clogged, thereby causing a reduction in reliability. When the content of the metal compound particles therein is less than 1% by mass, the color degree and whiteness of the ink composition are likely to be insufficient.

The metal compound particles preferably have an average size (outer diameter) of 0.01 to 1 μm, more preferably 30 to 600 nm, and further more preferably 200 to 400 nm. When the outer diameter of the metal compound particles is greater than 1 μm, the metal compound particles have low dispersion stability and therefore are likely to settle down. Furthermore, the hollow resin particles are likely to clog ink jet recording heads, thereby causing a reduction in reliability. When the outer diameter thereof is less than 0.01 μm, the metal compound particles are likely to have insufficient color density and whiteness.

The average size of the metal compound particles can be measured with a laser diffraction-scattering particle size distribution analyzer. A useful example of the laser diffraction-scattering particle size distribution analyzer is a dynamic light scattering particle size distribution analyzer, Microtrack UPA, available from Nikkiso Co., Ltd.

The ink composition contains the resin dispersion, which contains the resin particles 12. The resin particles 12 have an average size greater than that of the hollow resin particles or the metal compound particles. This allows the colorant 14 to be securely sufficiently fixed to the fabric sheet if the ink composition is applied to the fabric sheet only once and also allows the resin particles 12 to have a protective effect on the coating 10; hence, an image formed on the fabric sheet has good rubfastness.

The average size of the resin particles 12 is not particularly limited and is preferably greater than that of the hollow resin particles. The average size of the resin particles 12 is preferably 0.4 to 3 μm and more preferably 0.6 to 2.5 μm. The difference in average size between the resin particles 12 and the hollow resin particles or the metal compound particles is preferably 1 μm or more. When the average size of the resin particles 12 is greater than 3 μm, the resin particles 12 have low dispersion stability and therefore are likely to settle down. Furthermore, the resin particles 12 are likely to clog ink jet recording heads, thereby causing a reduction in reliability. When the average size of the resin particles 12 is less than 0.4 μm, no image with good rubfastness is possibly obtained. Furthermore, the average size of the resin particles 12 is preferably two times and more preferably 2.5 times greater than that of the hollow resin particles or the metal compound particles. The term “average size” as used herein refers to the diameter (average diameter) of particles measured by a microtrack method.

The resin particles 12 preferably have a ring and ball softening point of 110° C. or higher and more preferably 110° C. to 150° C. as determined in accordance with JIS K 2207 because the resin particles 12 are likely to remain in a film of the ink composition applied to a surface of a recording medium.

The resin particles 12 preferably have a penetration hardness of one or more and more preferably two to 15 as determined in accordance with JIS K 2207.

The resin particles 12 are preferably made of a polyurethane resin. Preferred examples of the polyurethane resin include polycarbonate-based anionic polyurethane resins and polyether-based anionic polyurethane resins.

General polyurethane resins can be formed into flexible, tough films because molecules of the polyurethane resins are loosely linked to each other through hydrogen bonds. Since the polyurethane resin is fluid at a temperature of 10° C. to 40° C., at which ink jet recording is usually performed, and spreads over a recording medium to form a flexible film, the use of the polyurethane resin allows an image having high fixability and good rubfastness to be formed. The polycarbonate- or polyether-based polyurethane resins are readily formed into more flexible films as compared to those formed from polyester-based polyurethane resins and therefore are useful in forming flexible images having good rubfastness. The polycarbonate- or polyether-based polyurethane resins have resistance to water and therefore are suitable for use in aqueous ink.

The polyurethane resin preferably has a glass transition temperature (Tg) of 50° C. or lower, more preferably 0° C. or lower, and further more preferably −10° C. or lower. When the polyurethane resin has a glass transition temperature of 50° C. or lower, the polyurethane resin spreads over a recording medium to form an image although the detailed reason for that is unclear. Therefore, the use of the polyurethane resin allows the hollow resin particles or the metal compound particles to be tightly fixed to the recording medium. This allows an image with good rubfastness to be obtained. In particular, when the polyurethane resin has a glass transition temperature of 0° C. or lower, the use of the polyurethane resin allows intermittent printability to be enhanced and prevents nozzle clogging during ink jet recording.

The polyurethane resin is used herein in the form of a dispersion containing particles dispersed in a solvent. Dispersions can be categorized into forcibly emulsified dispersions and self-emulsified dispersions. A forcibly emulsified dispersion and a self-emulsified dispersion can be used herein. In particular, the self-emulsified dispersion is preferably used herein. The self-emulsified dispersion is superior in film formability and water resistance to the forcibly emulsified dispersion and therefore can be used to form a water-resistant film.

In the case of using a resin dispersion containing particles of the polyurethane resin, the polyurethane resin particles preferably have an average size of 50 to 200 nm and more preferably 60 to 200 nm. When the polyurethane resin particles have such an average size, the polyurethane resin particles can be uniformly dispersed in the ink composition.

Examples of the polyurethane resin include forcibly emulsified polyurethane dispersions such as a polyurethane dispersion, Takelac® W-6061, available from Mitsui Chemicals, Inc. and self-emulsified polyurethane dispersions such as a polyurethane dispersion, Takelac® W-6021, available from Mitsui Chemicals, Inc. and a polyurethane dispersion, WBR-016U, available from Taisei Fine Chemical Co., Ltd., having a glass transition temperature of 20° C.

The content (solid content) of the polyurethane resin in the ink composition is preferably 0.5% to 10% and more preferably 0.5% to 5% on a mass basis. When the content of the polyurethane resin therein is greater than 10% by mass, the ink composition possibly has low reliability (clogging, ejection stability, or the like) and does not possibly have appropriate ink properties (viscosity and the like). When the content of the polyurethane resin therein is less than 0.5% by mass, the ink composition is insufficiently fixed to a recording medium and therefore any image with high rubfastness cannot be formed.

The resin particles 12, which are other than the polyurethane resin particles, are not particularly limited and may have a predetermined size when being present in a film, such as a recorded image coating, formed by applying the ink composition to a recording surface. The resin particles 12 may be made of a copolymer or wax produced from an olefin such as ethylene, propylene, or butylene or a derivative thereof. Examples of the resin dispersion include aqueous polyethylene dispersions containing water and polyethylene dispersed therein, aqueous polypropylene dispersions containing water and polypropylene dispersed therein, and aqueous polybutylene dispersions containing water and polybutylene dispersed therein. These dispersions may be used alone or in combination.

Commercially available examples of the aqueous polypropylene dispersions include an aqueous polypropylene dispersion, Chemipearl® W401, available from Mitsui Chemicals, Inc. and an aqueous polypropylene dispersion, Chemipearl® W500, available from Mitsui Chemicals, Inc. The aqueous polypropylene dispersion Chemipearl® W401 has a particle size of 1 μm, a ring and ball softening point of 110° C., a penetration hardness of four, and a solid content of 40%. The aqueous polypropylene dispersion Chemipearl® W500 has a particle size of 2.5 μm, a ring and ball softening point of 113° C., a penetration hardness of ten, and a solid content of 40%.

The content of the resin particles 12 in the ink composition is preferably 0.01% to 10% and more preferably 0.05% to 1% on a mass basis.

The ink composition preferably contains at least one selected from the group consisting of alkanediols and glycol ethers. The use of at least one of the alkanediols and the glycol ethers allows the ink composition to have increased wettability to recording surfaces of recording media and high permeability.

Preferred examples of the alkanediols include 1,2-alkanediols, such as 1,2-butanediol, 1,2-pentanediol, 1,2-hexanediol, 1,2-heptanediol, and 1,2-octanediol, containing four to eight carbon atoms. In particular, 1,2-hexanediol, 1,2-heptanediol, and 1,2-octanediol, which are 1,2-alkanediols containing six to eight carbon atoms, are preferred because these diols have high permeability to recording media.

Examples of the glycol ethers include polyol lower-alkyl ethers such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. In particular, triethylene glycol monobutyl ether is preferably used because good recording quality can be achieved.

The content of at least one of the alkane diols and the glycol ethers in the ink composition is preferably 1% to 20% and more preferably 1% to 10% on a mass basis.

The ink composition preferably contains an acetylene glycol surfactant or a polysiloxane surfactant. The use of the acetylene glycol or polysiloxane surfactant allows the ink composition to have increased wettability to recording surfaces of recording media and high permeability.

Examples of the acetylene glycol surfactant include 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol. Commercially available examples of the acetylene glycol surfactant include surfactants, Olfine E1010, Olfine STG, and Olfine Y, available from Nissin Chemical Industry Co., Ltd. and surfactants, Surfynol 104, Surfynol 82, Surfynol 465, Surfynol 485, and Surfynol TG, available from Air Products and Chemicals Inc.

Commercially available examples of the polysiloxane surfactant include surfactants, BYK-347 and BYK-348, available from Byk Chemie Japan K.K.

The ink composition may further contain an anionic surfactant, a nonionic surfactant, an amphoteric surfactant, or another surfactant.

The content of the acetylene glycol or polysiloxane surfactant in the ink composition is preferably 0.01% to 5% and more preferably 0.1% to 0.5% on a mass basis.

The ink composition preferably contains a polyol. In the case of using the ink composition for ink jet recording apparatuses, the use of the polyol can prevent the ink composition from being dried and also can prevent the ink composition from clogging head portions of the ink jet recording apparatuses.

Examples of the polyol include ethylene glycol, diethylene glycol, triethylene glycol, polyethylene glycol, polypropylene glycol, propylene glycol, butylene glycol, 1,2,6-hexane triol, thioglycol, hexylene glycol, glycerin, trimethylol ethane, and trimethylol propane.

The content of the polyol in the ink composition is preferably 0.1% to 3.0% and more preferably 0.5% to 2.0% on a mass basis.

The ink composition preferably contains a ternary amine. The ternary amine functions as a pH regulator and therefore can readily regulate the pH of the ink composition.

An example of the ternary amine is triethanolamine.

The content of the ternary amine in the ink composition is preferably 0.01% to 10% and more preferably 0.1% to 2% on a mass basis.

The ink composition preferably contains water such as pure or ultrapure water including ion-exchanged water, ultrafiltered water, reverse osmosis-purified water, or distillated water. In particular, water sterilized by ultraviolet irradiation or by the use of hydrogen peroxide is preferred because fungi and bacteria can be prevented from growing therein over a long period of time.

The ink composition may contain a fixative such as water-soluble rosin, an antimildew or antiseptic agent such as sodium benzoic acid, an anti-oxidation or ultraviolet-absorbing agent such as an allophanate, a chelating agent, an oxygen absorber, or another additive. These additives may be used alone or in combination.

The ink composition can be prepared by substantially the same process as that used to prepare a conventional pigment ink using a conventional apparatus such as a ball mill, a sand mill, an attritor, a basket mill, or a roll mill. Coarse particles are preferably removed from the ink composition with a membrane filter or a mesh filter.

Images can be formed by applying the ink composition to various recording media. The fabric sheet is used herein as a recording medium. Examples of the fabric sheet include a sheet of woven fabric, a sheet of knitted fabric, and a sheet of nonwoven fabric. Fibers contained in the fabric sheet are not particularly limited and may be natural fibers such as cotton (for example, sheeting) fibers, silk fibers, hemp fibers, and wool fibers; synthetic fibers such as polyamide fibers, polyester fibers, and acrylic fibers; regenerated or semi-synthetic fibers such as rayon fibers and acetate fibers; and mixtures of these fibers.

The image-forming method includes an image-forming step of forming an image on the fabric sheet with the ink composition and a pressuring step of pressuring the fabric sheet subsequently to the image-forming step.

In the image-forming step, an ink jet recording process can be used. Examples of the ink jet recording process include thermal ink jet processes, piezoelectric ink jet processes, continuous ink jet processes, roller application processes, and spray application processes.

The pressuring step may be performed under heating conditions. In the pressuring step, at least one of the following tools may be used: a hot press, a laminator, a laser, a heating tool, an iron, a dryer, an ultraviolet heater, a ceramic heater, and the like.

The heating temperature of the fabric sheet is preferably, for example, 30° C. to 120° C. and more preferably 50° C. to 100° C. The pressuring time of the fabric sheet is preferably, for example, one to 90 seconds and more preferably five to 60 seconds.

Performing the pressuring step allows the colorant 14 to be fixed, thereby forming a coating with good fastness. Furthermore, a coating with good fastness can be formed in such a manner that the fabric sheet is heated to a temperature higher than or equal to the glass transition temperature or softening point of the resin particles 12.

### EXAMPLES

The present invention is further described below in detail with reference to examples. The present invention is not limited to the examples.

### Examples 1 to 4 and Comparative Examples 1 and 2

A white ink composition was prepared in each of Examples 1 to 4 and Comparative Examples 1 and 2 by the following procedure: hollow resin particles, metal compound particles, a resin dispersion, an organic solvent, a polyol, a ternary amine, a surfactant, and ion-exchanged water were mixed at a ratio shown in Table 1; the mixture was filtered through a metal filter with a pore size of 5 μm; and the obtained filtrate was degassed with a vacuum pump. Values shown in Table 1 are in mass percent.

Components shown in Table 1 are described below.

The hollow resin particles used were those contained in an aqueous dispersion, SX8782(D) or SX866(B), commercially available from JSR Corporation as shown in Table 1. Particles contained in the aqueous dispersion SX8782(D) had an outer diameter of 1.0 μm and an inner diameter of 0.8 μm. The aqueous dispersion SX8782(D) had a solid concentration of 28%. Particles contained in the aqueous dispersion SX866(B) had an outer diameter of 0.3 μm and an inner diameter of 0.2 μm. The aqueous dispersion SX866(B) had a solid concentration of 20%.

The metal compound particles used were those contained in a commercial slurry, NanoTek (R) Slurry, available from C. I. Kasei Co., Ltd. as shown in Table 1. The slurry contained 15% titanium oxide particles with an average size of 36 nm.

The resin particles used were those contained in a self-emulsified dispersion containing a polyether-based anionic polyurethane resin, Resamine D2020, available from Dainichiseika Color & Chemicals Mfg. Co., Ltd.; those contained in a self-emulsified dispersion, U-1, prepared as described below; those contained in an aqueous polyethylene dispersion, Chemipearl® W401, available from Mitsui Chemicals, Inc.; or those contained in an aqueous polyethylene dispersion, Chemipearl® W500, available from Mitsui Chemicals, Inc.

The self-emulsified dispersion containing the polyether-based anionic polyurethane resin Resamine D2020 had an average particle size of 100 μm. The polyether-based anionic polyurethane resin Resamine D2020 had a glass transition temperature of −30° C.

The self-emulsified dispersion U-1 contained a polycarbonate-based anionic polyurethane resin having a glass transition temperature of −70° C. and had an average particle size of 130

The self-emulsified dispersion U-1 was prepared as described below. In a reaction vessel equipped with a heater, an agitator, a thermometer, a cooler, and a dropping unit, 1 mol of polycarbonate with a number-average molecular weight of 2,000 and 0.7 mol of 1,6-hexanediol were dissolved in dimethylformamide (DMF), whereby a 30% DMF solution was prepared. To the 30% DMF solution, 1.7 mol of 4,4-diphenylmethane diisocyanate was added, whereby a mixture with an NCO/OH molar ratio of 1.0 was prepared. The mixture was subjected to reaction at 100° C. until the 2,270 cm⁻¹ peak, due to free isocyanate groups, was not observed in an ultraviolet absorption spectrum, whereby a polyurethane resin solution was prepared. The polyurethane resin solution was dispersed in water by a known process, whereby the aqueous polyurethane resin dispersion U-1 was obtained. The aqueous polyurethane resin dispersion U-1 had a solid content of 40% and a viscosity of 20 to 800 mPa·s at 25° C.

The aqueous polyethylene dispersion Chemipearl® W401 had a particle size of 1 μm and a solid content of 40% and contained polyethylene particles having a ring and ball softening point of 110° C. and a penetration hardness of four.

The aqueous polyethylene dispersion Chemipearl® W500 had a particle size of 2.5 μm and a solid content of 40% and contained polyethylene particles having a ring and ball softening point of 113° C. and a penetration hardness of ten.

The surfactant used was a polysiloxane surfactant, BYK-348, available from Byk Chemie Japan K.K.

The white ink compositions shown in Table 1 were evaluated for fastness (rubfastness) as described below. Each white ink composition was loaded into a black ink chamber of an ink cartridge intended for use in an ink jet printer, PX-G930, available from Seiko Epson Corporation. The ink cartridge was installed in the ink jet printer and then used for a printing test. Commercially available ink cartridges other than the ink cartridge having the black ink chamber were installed in the ink jet printer. The commercially available ink cartridges were for use as dummies and were not used for evaluation in the examples. Therefore, the commercially available ink cartridges were not involved in any advantages.

A solid pattern with a duty of 100% was printed on a sheet of fabric (100% cotton sheeting) at a resolution of 720×720 dpi using the white ink composition.

The resulting fabric sheet was pressed at 90° C. with an iron.

The term “duty” as used herein is defined by the following equation:

D=N/(V×H)×100

wherein D is the duty in percent, N is the number of printed dots per unit area, V is the vertical resolution per unit area, and H is the horizontal resolution per unit area. A duty of 100% corresponds to the maximum mass of a single color ink.

The resulting fabric sheet was dried at room temperature for one hour. The dried fabric sheet was subjected to a nail-rubbing test by a testing staff. Evaluation standards were as described below.

AA: A printed pattern having no scratch

A: A printed pattern having a slight scratch

B: A printed pattern having no stripped portion but scratches

C: A printed pattern having a stripped portion

The evaluation results are summarized in Table 1.

TABLE 1

| | | | | | Comparative | |
|---|---|---|---|---|---|---|
| | Examples | | | | Examples | |
| Components | 1 | 2 | 3 | 4 | 1 | 2 |
| Hollow resin particles | — | 10.0 | 10.0 | — | — | 10.0 |
| (SX8782(D)) | | | | | | |
| Hollow resin particles | — | — | — | 10.0 | 10.0 | — |
| (SX866(B)) | | | | | | |
| Metal compound particles | 10.0 | — | — | — | — | — |
| (titanium oxide, NanoTek(R) | | | | | | |
| Slurry) | | | | | | |
| Resamine D2020 | 5.0 | — | — | — | — | — |
| U-1 | — | 5.0 | — | — | — | — |
| Chemipearl ® W500 | — | — | 0.8 | — | — | — |
| Chemipearl ® W401 | — | — | — | 1.0 | — | 1.0 |
| Glycerin | 10.0 | 10.0 | 10.0 | 10.0 | 10.0 | 10.0 |
| 1,2-hexanediol | 3.0 | 3.0 | 3.0 | 3.0 | 3.0 | 3.0 |
| Triethanolamine | 0.5 | 0.5 | 0.5 | 0.5 | 0.5 | 0.5 |
| BYK-348 | 0.5 | 0.5 | 0.5 | 0.5 | 0.5 | 0.5 |
| Ion-exchanged water | Balance | Balance | Balance | Balance | Balance | Balance |
| Total | 100.0 | 100.0 | 100.0 | 100.0 | 100.0 | 100.0 |
| Fastness (nail-rubbing test) | AA | AA | B | A | C | C |

### Example 5

A pattern was printed on a sheet of fabric in substantially the same manner as that used in Example 3 except that the resulting fabric sheet was pressed at 120° C. The pattern was tested for fastness in the same manner as that used in Example 3. As a result, the pattern was evaluated to be A.

### Example 6

A pattern was printed on a sheet of fabric in substantially the same manner as that used in Example 4 except that the resulting fabric sheet was pressed at 120° C. The pattern was tested for fastness in the same manner as that used in Example 4. As a result, the pattern was evaluated to be AA.

In an image-forming method according to the present invention, resin particles having an average size greater than the average particle size of a colorant are used as a fixative. Therefore, the colorant can be sufficiently fixed even if hollow resin particles having an average size greater than the average particle size of another colorant are used and an image is formed by a single application. The results of Examples 1 to 4 suggest that resin particles having an average size greater than the average particle size of a colorant are useful in forming an image with good fastness on a sheet of fabric. The fastness of the image can be increased in such a manner that the fabric sheet is heated at a temperature higher than or equal to the glass transition temperature or softening point of the resin particles while being pressed.

The present invention is not limited to the above embodiments and various modifications can be made. The present invention covers configurations (for example, configurations substantially equivalent in function, process, and result to or configurations substantially equivalent in purpose and effect to) substantially equivalent to those described in the embodiments. The present invention covers configurations formed by replacing nonessential portions of the configurations described in the embodiments with others. The present invention covers configurations capable of providing the same advantages as those of the configurations described in the embodiments or capable of achieving the same objects as those of the configurations described in the embodiments. Furthermore, the present invention covers combinations of the configurations described in the embodiments and known techniques.

What is claimed is:

1. An image-forming method for forming an image on a sheet of fabric with an ink composition, comprising:
forming the image on the fabric sheet with the ink composition; and
pressing the fabric sheet subsequently to the formation of the image,
wherein the ink composition contains a colorant containing hollow resin particles or metal compound particles and also contains a resin dispersion containing resin particles having an average size greater than the average particle size of the colorant.

2. The image-forming method according to claim 1, wherein the average size of the resin particles is 2.5 times greater than the average particle size of the colorant.

3. The image-forming method according to claim 1, wherein the colorant has an average particle size of 0.01 to 1 μm.

4. The image-forming method according to claim 1, wherein the difference between the average particle size of the colorant and the average size of the resin particles is 1 μm or more.

5. The image-forming method according to claim 1, wherein the content of the colorant in the ink composition is 5% to 20% by mass.

6. The image-forming method according to claim 1, wherein the resin particles are made of a polyurethane resin.

7. The image-forming method according to claim 1, wherein the image is formed under heating conditions.

8. The image-forming method according to claim 1, wherein the heating temperature is higher than or equal to the glass transition temperature or softening point of the resin particles.

9. The image-forming method according to claim 1, applicable to ink jet recording methods.

10. A record obtained by the image-forming method according to claim 1.
